(19) United States
(12) Patent Application Publication
(10) Pub. No.: US 2026/0200146 A1
(43) Pub. Date: Jul. 16, 2026

(54) AIRBAG BOX INJECTION MOLDING SYSTEM

(71) Applicant: DO LIM INDUSTRY CO., LTD., Ulsan (KR)

(72) Inventors: Sung Gye PARK, Gimpo-si, Gyeonggi-do (KR); Seong Ju KIM, Ulsan (KR); Young Taek SONG, Ulsan (KR); Young Hun LEE, Ulsan (KR); Nam Kyu KIM, Ulsan (KR); Ki Young KIM, Ulsan (KR); Sang Cho LEE, Ulsan (KR)

(21) Appl. No.: 19/134,628

(22) PCT Filed: Mar. 27, 2024
(86) PCT No.: PCT/KR2024/003869

§ 371 Date: May 30, 2025

(30) Foreign Application Priority Data
Mar. 30, 2023 (KR) 10-2023-0042157

(51) Int. Cl. B29C 45/14; B29C 45/42; B29L 22/02

(52) U.S. Cl. CPC B29C 45/14008; B29C 45/42; B29K 2715/00; B29L 2022/027

(57) ABSTRACT

Proposed is an injection molding system for an airbag box for injecting molding an airbag box with high reliability. The injection molding system includes a mold for injection molding an airbag box, a gantry, a seating base on which an anti-scattering mesh member is seated, a transfer unit that is movable by the gantry and transfers the anti-scattering mesh member, seated on the seating base, into the mold, and an extraction unit that is movable by the gantry and extracts the injection molded airbag box from the mold.

### TECHNICAL FIELD

The present disclosure relates to an injection molding system for an airbag box.

### Background Art

Airbags are safety devices designed to deploy toward the occupants in the event of a collision to protect the driver and passengers in vehicles. An airbag is installed in the driver's seat or passenger's seat. When installing an airbag in the driver's seat or passenger's seat, a housing that stores the airbag is called an airbag box.

In general, airbag boxes can be made of metal or plastic. When making airbag boxes out of metal, there are problems such as the weight of the airbag box being heavy and the unit price being high. In contrast, making airbag boxes out of plastic has the advantage of being lighter and cheaper than a metal airbag box, but when an airbag deploys, as it expands from inside an airbag box to the outside, a door provided in the airbag box is damaged, and a passenger may be injured by fragments of the damaged door.

Korean Patent Application Publication No. 10-2021-0090361 discloses a scrim-integrated airbag door and a manufacturing method thereof.

The scrim-integrated airbag door published in the above document includes: a fracture part that is ruptured by the inflation of an airbag, including a fracture line formed through a crash pad; and a scrim partially embedded in the material of the crash pad and installed on the crash pad so that the remaining portion, which is not embedded, covers the fracture part on the inside of the crash pad. The manufacturing method of the airbag door includes: a process for molding the crash pad so that the fracture part is created through which the fracture line is formed that fractures due to the inflation of the airbag; and a process of installing the scrim, during the crash pad molding process, so that a portion thereof is embedded in the material of the crash pad and the remaining portion, which is not embedded, covers the fracture part on the inside of the crash pad.

However, in the process of manufacturing the aforementioned scrim-integrated airbag door, the scrim often gets rolled up or wrinkles, which reduces the marketability of the manufactured airbag door.

### DISCLOSURE

### Technical Problem

An objective of the present disclosure is to provide an injection molding system for an airbag box for injection molding an airbag box with high reliability.

### Technical Solution

An injection molding system for an airbag box according to an embodiment includes: a mold for injection molding an airbag box; a gantry; a seating base on which an anti-scattering mesh member is seated; a transfer unit that is movable by the gantry and transfers the anti-scattering mesh member seated on the seating base, into the mold; and an extraction unit that is movable by the gantry and extracts the injection molded airbag box from the mold.

In addition, the transfer unit of the injection molding system for an airbag box according to an embodiment may include: a body rotatably coupled to the gantry; a first slider provided in a pair on a first side of the body, wherein the first sliders move in a diagonal direction away from each other; a second slider provided in a pair on a second side of the body, wherein the second sliders move in a diagonal direction away from each other; a needle provided at each end of the first and second sliders; a support plate positioned below the needle and configured to have a slit formed through which the needle passes; and a damper coupled to the body and positioned near the support plate.

In addition, the seating base of the injection molding system for an airbag box according to an embodiment may include: a top plate supported by legs and on which the anti-scattering mesh member is fixed; a guide pin provided on the top plate and inserted into a guide hole formed in the anti-scattering mesh member to guide the anti-scattering mesh member; a through hole formed on the top plate and through which the needle passes; and a sensor provided on the top plate and configured to detect whether the anti-scattering mesh member is secured to the top plate.

In addition, the guide pin of the injection molding system for an airbag box according to an embodiment may be pushed downward by the support plate when the guide pin comes into contact with the support plate.

### Advantageous Effects

According to the present disclosure, an airbag box injection molded by the injection molding system for an airbag box according to an embodiment is insert injection molded with the anti-scattering mesh member in a flat state, thereby reducing the defect rate of airbag boxes.

Furthermore, the injection molding system for an airbag box according to an embodiment is equipped with needles that are symmetrically arranged and move diagonally away from each other. Due to this, the anti-scattering mesh member that is installed on the seating base can be transferred while being stably fixed.

Furthermore, the injection molding system for an airbag box according to an embodiment is configured such that the guide pin can move downward. Due to this, the anti-scattering mesh member can be stably fixed until the transfer unit contacts the seating base.

### DESCRIPTION OF DRAWINGS

FIG. 1 schematically illustrates an injection molding system for an airbag box according to an embodiment.

FIG. 2 is a perspective view of a seating base.

FIG. 3 is a side view of a seating base.

FIG. 4 is a plan view of a seating base.

FIG. 5 is a plan view of a seating base with an anti-scattering mesh member installed thereof.

FIG. 6 is a perspective view of a transfer unit.

FIG. 7 is a side view of a transfer unit.

FIG. 8 is a bottom view of a transfer unit.

FIG. 9 schematically shows the operation of a transfer unit.

FIG. 10 schematically shows the operation of a transfer unit.

FIG. 11 schematically shows the operation of a transfer unit.

FIG. 12 schematically shows the operation of a transfer unit.

FIG. 13 is a perspective view of an anti-scattering mesh member.

FIG. 14 is a perspective view of an airbag box.

### MODE FOR INVENTION

The advantages and features of the present disclosure and the methods for achieving them will become apparent by reference to the embodiments described in detail below together with the accompanying drawings. However, the present disclosure is not limited to the embodiments disclosed below and may be implemented in various different forms. The embodiments are provided solely to make the present disclosure complete and to fully inform those skilled in the art of the scope of the present disclosure, and the present disclosure is defined solely by the scope of the claims. Throughout the specification, identical reference numerals refer to identical components.

Before explaining an injection molding system 10 for an airbag box [hereinafter referred to as “injection molding system 10”], according to an embodiment, an anti-scattering mesh member M inserted into the injection molding system 10 and an airbag box B injection molded from the injection molding system 10 will be described.

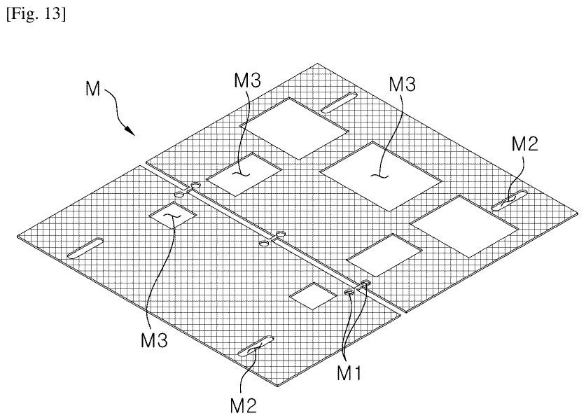

Referring to FIG. 13, which is a perspective view of the anti-scattering mesh member M, the anti-scattering mesh member M has a mesh shape, and two surfaces thereof are connected in the width direction by multiple thin lines.

In addition, the anti-scattering mesh member M is formed with a guide hole M1, an auxiliary guide hole M2, and a wrinkle prevention hole M3.

A plurality of guide holes M1 may be symmetrically provided on the inside of the anti-scattering mesh member M, and may serve to guide the position of the anti-scattering mesh member M when the anti-scattering mesh member M is positioned on a mold 100 and a seating base 300 described later.

A plurality of auxiliary guide holes M2 may be symmetrically provided along the edge of the anti-scattering mesh member M, and may serve to guide the position of the anti-scattering mesh member M when the anti-scattering mesh member M is positioned on the mold 100 and the seating base 300 described later.

A plurality of wrinkle prevention holes M3 may be provided in the anti-scattering mesh member M, and may serve to prevent wrinkles from forming on the anti-scattering mesh member M when anti-scattering mesh member M is transferred by a transfer unit 400 described later. In addition, the wrinkle prevention holes M3 may serve to prevent the anti-scattering mesh member M from forming wrinkles inside an injection-molded product when insert injection molding is performed inside the mold 100 described later.

The anti-scattering mesh member M may be manufactured from a PET-based synthetic resin material.

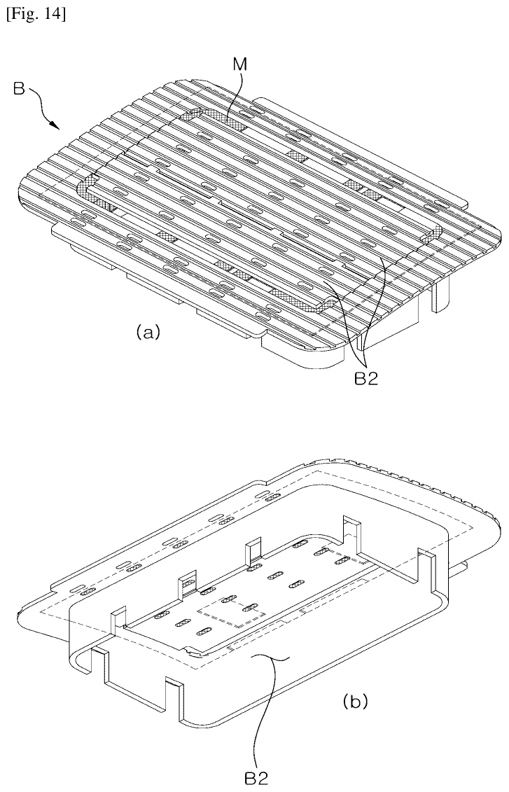

Referring to FIG. 14, which is a perspective view of the airbag box B, the airbag box B is composed of: a side surface surrounding a hollow B1; and an upper surface joined to the upper end of the side surface and having an opening formed therein that communicates with the hollow B1. The opening of the upper surface of the airbag box B is provided with a pair of doors B2 to block the opening.

In addition, in each of the doors B2 of the airbag box B, each of the two surfaces constituting the anti-scattering mesh member M is insert injection molded.

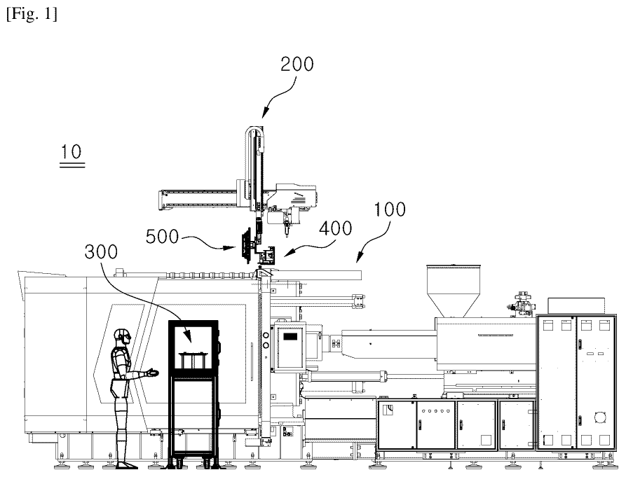

Referring to FIG. 1, which schematically illustrates the injection molding system 10, the injection molding system 10 includes the mold 100, a gantry 200, the seating base 300, the transfer unit 400, and an extraction unit 500.

The mold 100 is a mold for insert injection molding the airbag box B. When the anti-scattering mesh member M is transferred inside, the airbag box B is injection molded with the anti-scattering mesh member M inserted into the upper surface of the airbag box B.

The gantry 200 is installed movably near the mold 100. To be specific, the gantry 200 serves to move the transfer unit 400 and the extraction unit 500 near the mold 100. The gantry 200 may be replaced with a manipulator, etc.

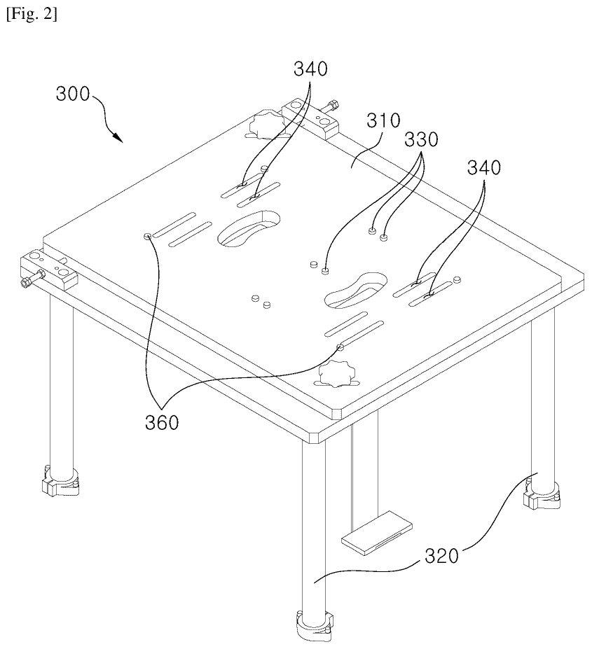

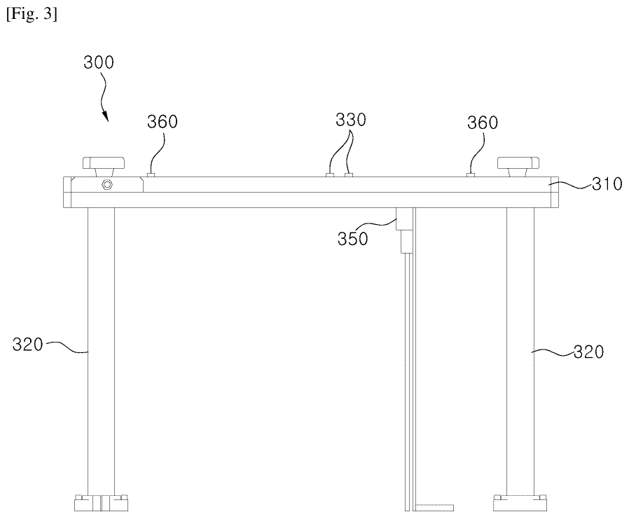

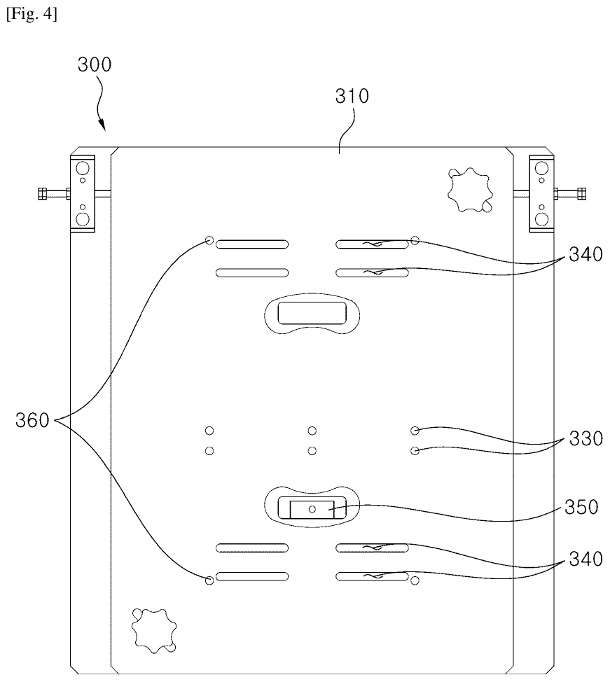

The seating base 300 is where the anti-scattering mesh member M is seated, and the seating base 300 is installed near the mold 100. To be specific, referring to FIG. 2, which is a perspective view of the seating base 300, FIG. 3, which is a side view of the seating base 300, FIG. 4, which is a plan view of the seating base 300, the seating base 300 includes a top plate 310, legs 320, a guide pin 330, a through hole 340, and a sensor 350.

The top plate 310 has a flat plate shape with a predetermined width, and the anti-scattering mesh member M is seated thereon. A plurality of holes that penetrate vertically through the top plate 310 is formed to facilitate the flow of air. Due to this, the anti-scattering mesh member M may be prevented from partially floating in the air or moving due to the air flow that occurs when the transfer unit 400 described later approaches the top plate 310.

The legs 320 support the top plate 310 so that the top plate 310 is positioned at a predetermined height. By positioning the top plate 310 at a predetermined height, the legs 320 prevent the anti-scattering mesh member M seated on the top plate 310 from being moved due to other factors or foreign substances from being attached to the anti-scattering mesh member M.

A plurality of guide pins 330 is provided on the upper surface of the top plate 310. Specifically, the plurality of guide pins 330 is provided symmetrically at the center of the upper surface of the top plate 310 and are inserted into the guide holes M1 of the anti-scattering mesh member M to guide and support the anti-scattering mesh member M.

In addition, the guide pins 330 may be configured such that when pressure is applied to the guide pins 330, the guide pins 330 may be pushed downward so that the upper surfaces of the guide pins 330 are parallel to the upper surface of the top plate 310. That is, the guide pins 330 slide into the interior of the top plate 310.

A plurality of through holes 340 is formed on the upper surface of the top plate 310. To be specific, the through holes 340 are provided at positions corresponding to needles 440 of the transfer unit 400 described later, and the needles 440 pass through the through holes 340.

The sensor 350 may be installed inside or underneath the top plate 310 and has the function of checking whether the anti-scattering mesh member M is installed.

A plurality of auxiliary guide pins 360 are provided on the upper surface of the top plate 310. To be specific, the auxiliary guide pins 360 are provided along the upper edge of the top plate 310 and are inserted into the auxiliary guide holes M2 of the anti-scattering mesh member M to guide and support the anti-scattering mesh member M.

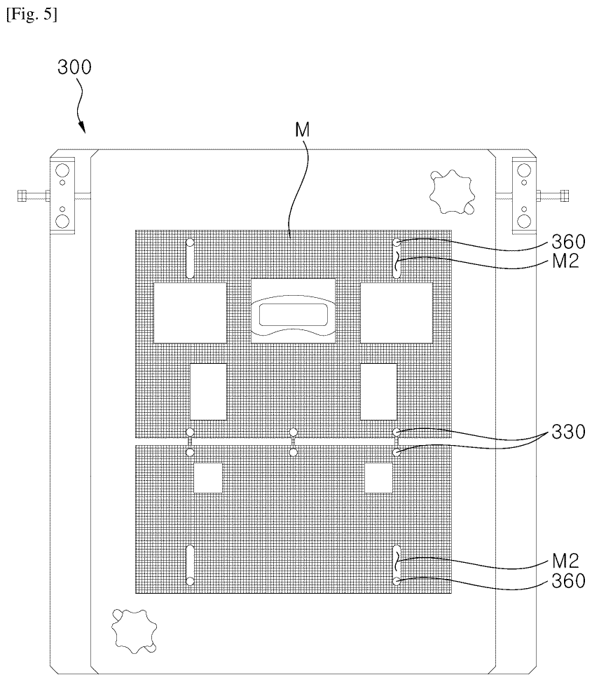

Referring to FIG. 5, which is a plan view of the seating base 300 on which the anti-scattering mesh member M is seated, the anti-scattering mesh member M is seated on the upper surface of the seating base 300. At this time, the guide pins 330 are inserted into the guide holes M1, and the auxiliary guide pins 360 are inserted into the auxiliary guide holes M2, so that the anti-scattering mesh member M is fixed to the seating base 300.

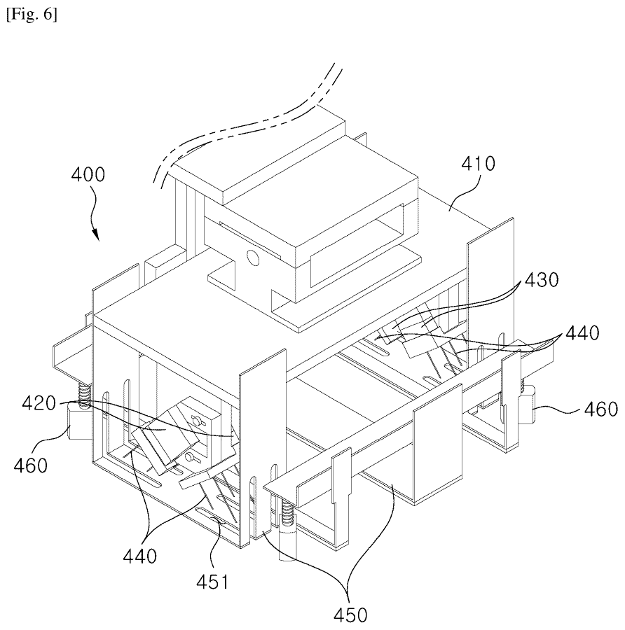

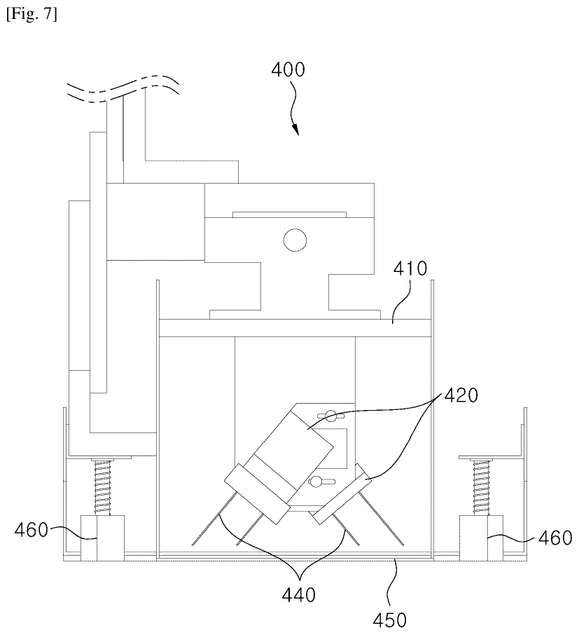

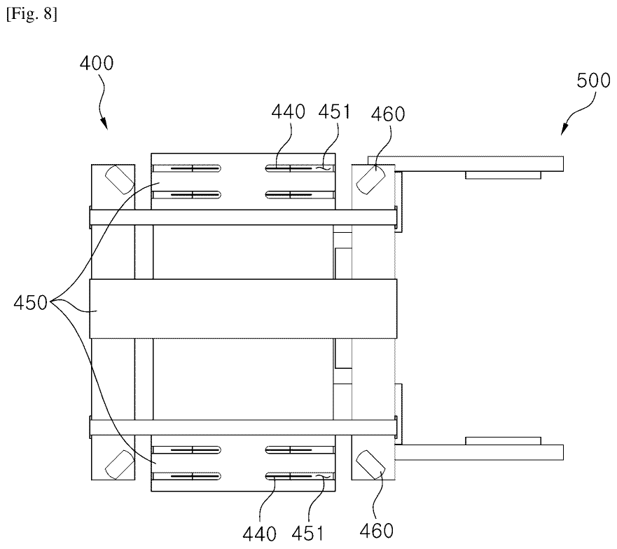

The transfer unit 400 is movably connected to the gantry 200 and has the function of transferring the anti-scattering mesh member M secured to the seating base 300 to the inside of the mold 100. To be specific, referring to FIG. 6, which is a perspective view of the transfer unit 400, FIG. 7, which is a side view of the transfer unit 400, FIG. 8, which is a bottom view of the transfer unit 400, the transfer unit 400 includes a body 410, a first slider 420, a second slider 430, the needles 440, and a support plate 450.

The body 410 is movably coupled to the gantry 200. Specifically, the body 410 is rotatably coupled around the gantry 200 and configured to be movable by the gantry 200.

The first slider 420 is provided in a pair on one side of the body 410. Each of the first sliders 420 is configured to move in a diagonal direction away from each other. To be specific, the first sliders 420 are coupled parallel or with backs thereof facing each other to one side of the body 410, and the first sliders 420 move away from each other and move away from the gantry 200. That is, the first sliders 420 are configured to move diagonally downward while moving away from each other.

The second slider 430 is provided in a pair on the other side of the body 410. Each of the second sliders 430 is configured to move in a diagonal direction away from each other. To be specific, the second sliders 430 are coupled parallel or with backs thereof facing each other to the other side of the body 410, and the second sliders 430 move away from each other and move away from the gantry 200. That is, the second sliders 430 are configured to move diagonally downward while moving away from each other.

The needles 440 are provided at each end of the pair of first sliders 420 and the pair of second sliders 430 and are configured to move together with the first sliders 420 and the second sliders 430. The needles 440 are inserted into the anti-scattering mesh member M and serves to fix the anti-scattering mesh member M.

The first slider 420 and the second slider 430 may be configured to be symmetrical left and right with respect to the body 410. As a result, the needles 440 may be stably inserted into the edge of the anti-scattering mesh member M to secure the anti-scattering mesh member M.

The support plate 450 is positioned below the needles 440, and a slit 451 through which the needle 440 passes is formed. To be specific, the support plate 450 has a plate shape with a predetermined width, and opposite ends thereof are connected to the body 410 and are positioned below the needles 440. A plurality of slits through which needles 440 pass may be formed in the support plate 450. In addition, the support plate 450 may serve to press the anti-scattering mesh member M seated on the seating base 300 to secure the anti-scattering mesh member M while the needles 440 are inserted into the anti-scattering mesh member M, serve to prevent the anti-scattering mesh member M from wrinkling, and serve to protect the needles 440.

The transfer unit 400 may further include a damper 460.

The damper 460 is coupled to the body 410 and located near the support plate 450. To be specific, the damper 460 is coupled to the body 410 and may be provided in parallel with the support plate 450. Due to this, when the support plate 450 presses the anti-scattering mesh member M seated on the seating base 300, the damper 460 comes into contact with the top plate 310 of the seating base 300 and functions to absorb the shock generated between the seating base 300 and the transfer unit 400.

Referring again to FIG. 1, the extraction unit 500 is movably connected to the gantry 200 and serves to extract the airbag box B injection molded from the mold 100. To be specific, the extraction unit 500 is rotatably coupled around the gantry 200 and configured to be movable by the gantry 200. In addition, the extraction unit 500 may extract the airbag box B from the mold 100 by using a method such as a vice or a suction plate.

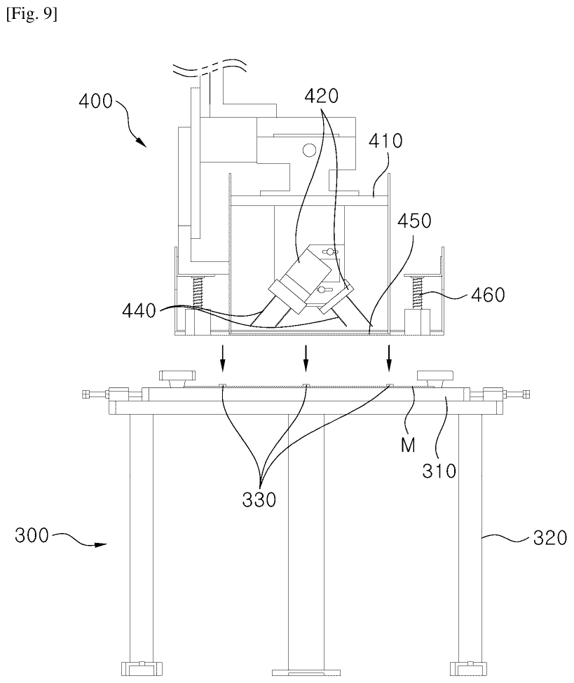

Referring to FIGS. 9 to 12, which schematically illustrate the operation of the transfer unit 400, the process of fixing and transferring the anti-scattering mesh member M seated on the seating base 300 by the transfer unit 400 is described.

FIG. 9 shows a view of the anti-scattering mesh member M being installed on the seating base 300. At this time, the guide pins 330 of the seating base 300 are inserted into the guide holes M1 of the anti-scattering mesh member M, and the auxiliary guide pins 360 of the seating base 300 are inserted into the auxiliary guide holes M2, so that the anti-scattering mesh member M is fixed to the seating base 300.

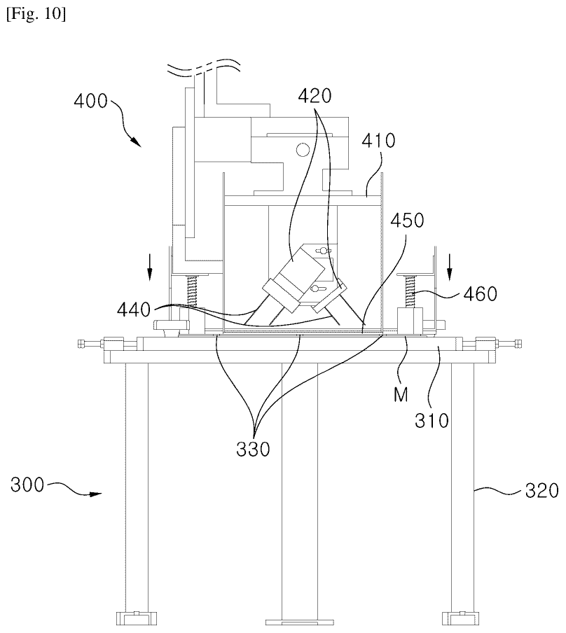

FIG. 10 shows a state in which the transfer unit 400 moves downward toward the seating base 300, and the upper surfaces of the guide pins 330 of the seating base 300 and the lower surface of the support plate 450 of the transfer unit 400 come into contact.

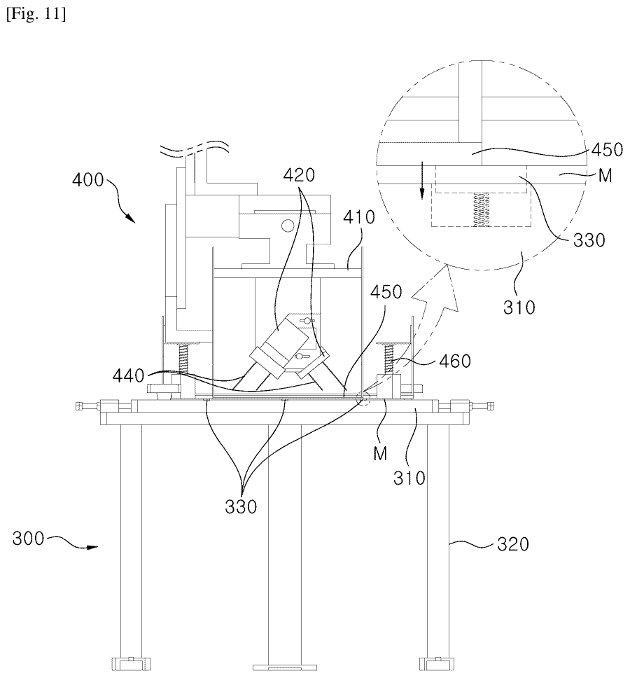

FIG. 11 shows a state in which the transfer unit 400 further moves downward toward the seating base 300, and the guide pins 330 of the seating base 300 are pushed downward by the support plate 450 of the transfer unit 400. To be specific, as the transfer unit 400 moves downward, the guide pins 330 also move downward. Due to this, the guide pins 330 may continue to guide the anti-scattering mesh member M until the support plate 450 comes into contact with the anti-scattering mesh member M, thereby maintaining the anti-scattering mesh member M in a flat state until the transfer unit 400 approaches and comes into contact with the anti-scattering mesh member M.

In addition, the guide pins 330 may prevent the anti-scattering mesh member M from partially floating in the air or changing the position thereof because of external factors or air flow generated when the transfer unit 400 approaches the top plate 310.

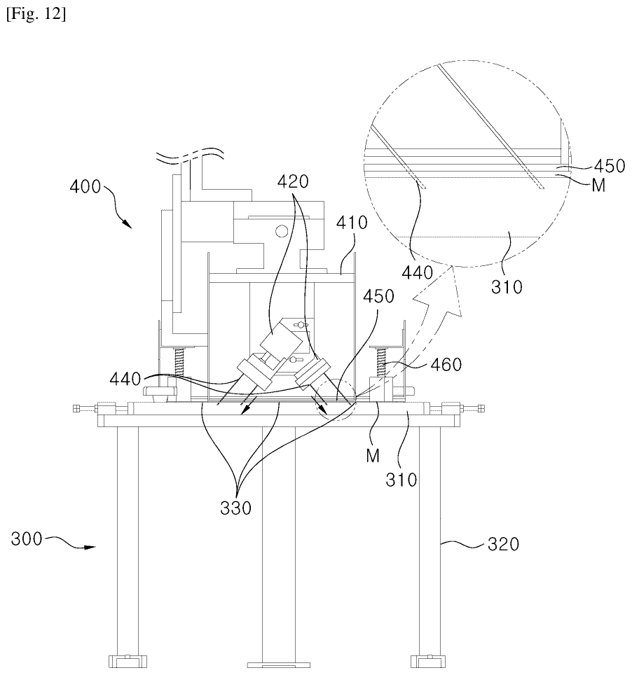

FIG. 12 shows a state in which the support plate 450 stably supports the anti-scattering mesh member M, and the needles 440 move diagonally downward to secure the anti-scattering mesh member M.

### *DESCRIPTION OF NUMERALS

100: mold
200: gantry
300: seating base
310: top plate
320: leg
330: guide pin
340: through hole
350: sensor
360: auxiliary guide pin
400: transfer unit
410: body
420: first slider
430: second slider
440: needle
450: support plate
451: slit
460: damper
500: extraction unit
M: anti-scattering mesh member
M1: guide hole
M2: auxiliary guide hole
M3: wrinkle prevention hole
B: airbag box
B1: hollow
B2: Door

The expressions (terms, visualized images, etc.) used in describing the embodiments of the present disclosure have been selected solely for the instrumental purpose of enhancing understanding of the technology.

In addition, due to circumstances, the present disclosure has been described by a limited number of embodiments, and a person skilled in the art will be able to create new embodiments within a scope that does not depart from the technical idea of the present disclosure based on the described embodiments.
Accordingly, the scope of the claims of the present disclosure should not be limited by some expressions appearing in the “Description of the Invention” and the “Drawings”, but should be broadly interpreted based on the original technical ideas inherent in the entire specification.

1. A system for injection molding an airbag box with an anti-scattering mesh member insert, the system comprising:
a mold for injection molding an airbag box;
a gantry;
a seating base on which the anti-scattering mesh member is seated;
a transfer unit configured to be movable by the gantry and to transfer the anti-scattering mesh member, seated on the seating base, into the mold; and
an extraction unit configured to be movable by the gantry and to extract the injection molded airbag box from the mold.

2. The system of claim 1, wherein the transfer unit comprises:
a body rotatably coupled to the gantry;
a first slider provided in a pair on a first side of the body, wherein the first sliders move in a diagonal direction away from each other;
a second slider provided in a pair on a second side of the body, wherein the second sliders move in a diagonal direction away from each other;
a needle provided at each end of the first and second sliders; and
a support plate positioned below the needle and configured to have a slit formed through which the needle passes.

3. The system of claim 2, further comprising:
a damper coupled to the body and positioned near the support plate.

4. The system of claim 2, wherein the seating base comprises:
a top plate supported by legs and on which the anti-scattering mesh member is fixed;
a guide pin provided on the top plate and inserted into a guide hole formed in the anti-scattering mesh member to guide the anti-scattering mesh member;
a through hole formed on the top plate and through which the needle passes; and
a sensor provided on the top plate and configured to detect whether the anti-scattering mesh member is secured to the top plate.

5. The system of claim 4, wherein the guide pin is pushed downward by the support plate when the guide pin comes into contact with the support plate.
